(19) United States
(12) Patent Application Publication
(10) Pub. No.: US 2004/0198416 A1
(43) Pub. Date: Oct. 7, 2004

(54) Adjustable detachable keyboard and electronic assembly using same

(76) Inventors: Michael R. Gardner, Plantation, FL (US); Alan R. Beatty, Plantation, FL (US); Russell L. Simpson, Miami, FL (US); Sybren D. Smith, Plantation, FL (US)

Correspondence Address: Scott M. Garrett, Motorola, Inc., Law Department, 8000 West Sunrise Boulevard, Fort Lauderdale, FL, 33322, US

(21) Appl. No.: 10/405,709

(22) Filed: Apr. 2, 2003

(51) Int. Cl. H04M 1/00

(52) U.S. Cl. 455/550.1; 455/556.1

(57) ABSTRACT

A keyboard (102) includes fist (112) and second (110) hinges that allow the keyboard (102) to be properly placed and fitted against an electronic device such as a cellular telephone (106). The first hinge (112) allows the keyboard 102 to be swung up and away from the cellular telephone's housing and also allows the keyboard (102) to be properly fit against the cellular telephone's housing when in use. This proper fit provides for improved stress relief away from connector (108) when the keys (104) are activated. The second hinge (110) makes it easy for the keyboard (102) to be attached to cellular telephone (106) using connector (108). The dovetail design (308) of the underneath of the keyboard provides amble clearance (302) for the cellular telephone's keys (304).

### TECHNICAL FIELD

This invention relates in general to the field of electronics, and more specifically to an adjustable detachable keyboard for use with electronic devices.

### BACKGROUND

With the trend in the electronics industry to smaller and smaller electronic devices such as portable cellular telephones, etc. there is less space available in the electronic device's housing for a keypad or keyboard. Some cellular telephones have solved this problem by offering smaller keys, however, this is typically not acceptable for some users, who find it hard to use small keys to type messages. Another problem with the keys found in typical cellular telephones is that they are the keys found in a standard telephone so typing a text message is very cumbersome and slow since each key represents a number and numerous letters.

A solution to the keyboard problem mentioned above is provided by the Ericsson Chatboard CHA-07 manufactured by Telefonaktiebolaget LM Ericsson, which is a snap-on 49 key mini-QWERTY keyboard. This keyboard has a top mounted connector that snaps into a connector at the bottom of cellular telephones that are electrically compatible with the keyboard. Although useful to send emails and other types of messages, this keyboard suffers from several major problems. Since this keyboard attaches to the bottom of the cellular telephone (dongle style) it is awkward to use. Also, since there is no support for the keyboard, it places undue mechanical stress on the cellular telephone's connector especially when a user is typing a message. Another problem with this keyboard is that since it attaches to the bottom of the telephone as mentioned previously, one needs to prop up the telephone in order to use it without straining ones neck while looking down at the screen. Given the above, a need exists in the art for a detachable keyboard that can help alleviate some of the problems mentioned above.

### BRIEF DESCRIPTION OF THE DRAWINGS

The features of the present invention, which are believed to be novel, are set forth with particularity in the appended claims. The invention, may best be understood by reference to the following description, taken in conjunction with the accompanying drawings, in the several figures of which like reference numerals identify like elements, and in which:

FIG. 1 shows a detachable adjustable keyboard in accordance with the invention attached to a cellular telephone.

FIG. 2 shows a partial side-view of the detachable adjustable keyboard shown in FIG. 1.

FIG. 3 shows a view of the keyboard and telephone taken along line 1-1 from FIG. 1.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

Referring now to FIG. 1, there is shown an electronic assembly 100 in accordance with the invention. Electronic assembly 100 includes an adjustable detachable keyboard 102 that includes one or more keys 104 located on the head portion 118 of the keyboard 102. An electrical connector 108 located on the connector portion 116 of the detachable keyboard 102 is used to electrically connect the keyboard 102 to a connector (not shown) on a cellular telephone 106 or other electronic device. Keyboard 102 includes a pair of pivot points formed by a first hinge 112 and a second hinge 110 located one either end of arm member 114.

The dual-hinge design allows the keyboard 102 to lay-level onto the telephone 106, thereby transferring most of the stress from the actuation of keys 104 onto the telephone's housing instead of the connector 108 or the telephone's mating receptacle. Also, given the dual hinge design, the user of the keyboard has the ability to rotate the head portion 118 of the keyboard 102 up and out of the way to expose the cellular telephone's control keys (see keys 304 in FIG. 3). This allows the telephone user quick access to the telephone's controls. Another major benefit of the design is that the keyboard is very close to the telephone's display making it easier for the user to see what is being typed.

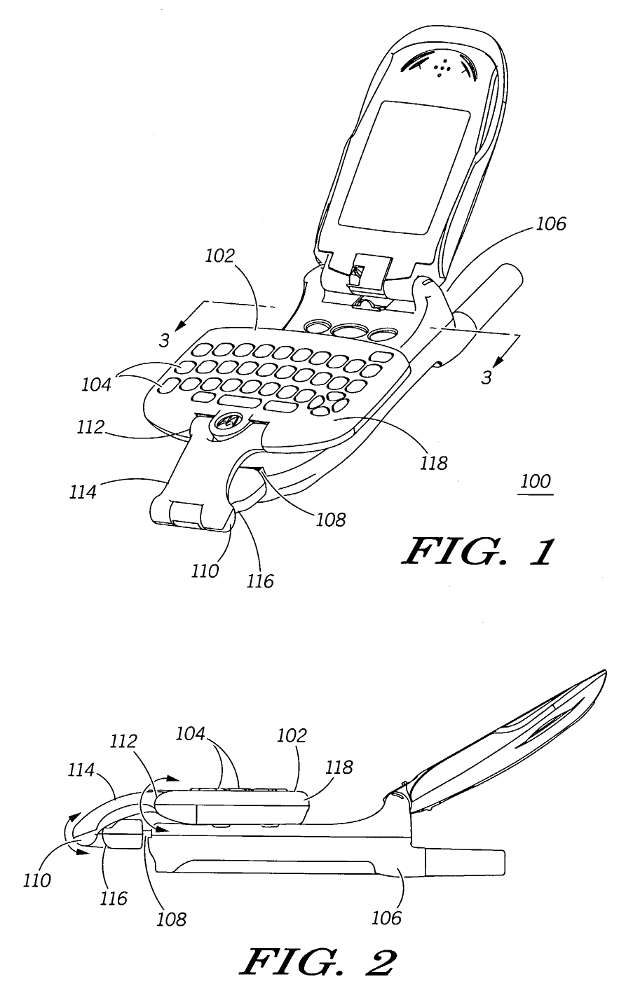

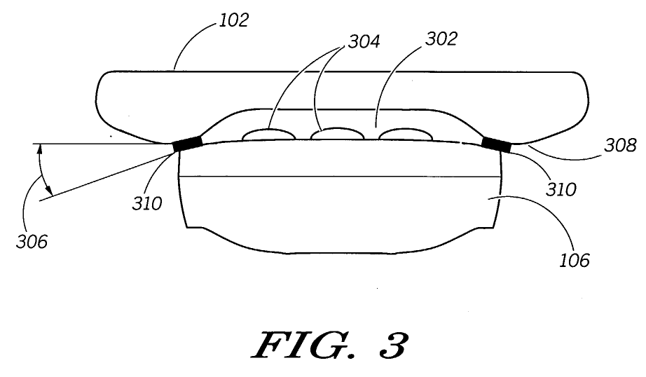

Referring now to FIG. 2, there is shown a side view of the keyboard 102 and cellular telephone 106. Hinge 112 allows the keyboard head portion 118 to swing up and away from the cellular telephone, while hinge 110 allows for ease of connection of the keyboard 102 by allowing for the entire keyboard assembly to be swung out of the way from connector 108. The arm portion 114 located between the two hinges 110 and 112 makes it possible for the keyboard 102 to be usable with a number of cellular telephones or other electronic devices having different shapes and sizes since the keyboard 102 can be bent to accommodate the different shapes and sizes.

In FIG. 3 there is shown a view taken along line 1-1 of FIG. 1. As shown, the underneath design of the keyboard head portion allows for clearance 302 for the existing keypad keys 304 of the telephone 106. The bottom portion or second major surface of the keyboard head portion utilizes an angled dovetail 308 mounting system.

This system adjusts by sitting lower until the angled sides having angle 306 make contact with the outer side surfaces of the cellular telephone 102. With different telephone widths, the dovetail self-adjusts and makes contact on a higher (or lower) point on the angled surface. Non-slip landing pads 310 are used to create a high friction coefficient point of contact between the angled contact points between the telephone 106 and the keyboard 102, as well as provide shock absorbency.

The adjustable detachable keyboard 102 makes for an excellent accessory to electronic devices such as cellular telephones, personal digital assistances (PDAs) and other electronic device that require a keyboard from time to time. The adjustable nature of the keyboard allows it to adjust to different sizes of devices, thereby allowing for one keyboard to be used with different devices. The adjustable keyboard 102 also provides for improved user ergonomics as compared to the prior art dongle connected. Due to its bendable shape that allows it to rest on top of the electronic device and close to the device's display makes using the keyboard easy to use.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A detachable keyboard for use with an electronic device, comprising:
a head portion having a plurality of keys;
an electrical connector electrically coupled to the plurality of keys;
an arm member located between the head portion and the electrical connector; and
a first hinge coupling the head portion to a first end of the arm member.

2. A detachable keyboard as defined in claim 1, wherein the first hinge allows the head portion to pivot away from the electronic device when the electrical connector is coupled to the electronic device.

3. A detachable keyboard as defined in claim 1, further comprising a second hinge located on a second end of the arm member.

4. A detachable keyboard as defined in claim 3, wherein the second hinge allows the arm member to pivot away from the electrical connector when the electrical connector is connected to the electronic device.

5. A detachable keyboard as defined in claim 3, wherein the head member includes a first major surface wherein the plurality of keys are located and a second major surface having an angled shape.

6. A detachable keyboard as defined in claim 5, wherein the second major surface includes at least one landing pad.

7. A detachable keyboard as defined in claim 5, wherein the at least one landing pad makes contact with the electronic device when the detachable keyboard is in use and the angled shape of the second major surface provides a clearance area between the head portion of the detachable keyboard and the electronic device.

8. An adjustable detachable keyboard, comprising:
a head portion having a plurality of keys;
an electrical connector portion; and
an arm member having first and second hinged ends, and the head portion is coupled to the first hinged end and the electrical connector portion is coupled to the second hinged end.

9. An adjustable detachable keyboard as defined in claim 8, wherein the first and second hinged ends allows the head portion and the electrical connector portions to pivot.

10. An adjustable detachable keyboard as defined in claim 9, wherein the head portion includes a first major surface where the plurality of keys is located and a second major surface having an angled shape.

11. An adjustable detachable keyboard as defined in claim 10, further comprising at least one landing pad attached to the second major surface.

12. An adjustable detachable keyboard as defined in claim 11, wherein an electrical connector located in the electrical connector portion is used to make electrical connection with an electronic device, and the angled shape of the second major surface provides for a clearance area when the at least one landing pad makes contact with the electronic device.

13. An electronic assembly, comprising:
an electronic device having a plurality of keys; and
a detachable keyboard electrically connected to the electronic device, the detachable keyboard including:
a head portion having a plurality of keys;
an electrical connector portion having an electrical connector for connecting to the electronic device; and
an arm member having first and second hinged ends, and the head portion is coupled to the first hinged end and the electrical connector portion coupled to the second hinged end.

14. An electronic assembly as defined in claim 13, wherein the first and second hinged ends allows the head portion and the electrical connector portions to pivot.

15. An electronic assembly as defined in claim 14, wherein the head portion of the detachable keyboard lies over the plurality of keys of the electronic device when the detachable keyboard is being used.

16. An electronic assembly as defined in claim 15, wherein the first hinge allows the head portion to rotate away from the electronic device allowing for access to the plurality of keys found in the electronic device.

17. An electronic assembly as defined in claim 15, wherein the head portion includes a first major surface where the plurality of keys is located and a second major surface having an angled shape.

18. An electronic assembly as defined in claim 17, wherein the angled shape of the second major surface provides clearance between the second major surface of the head portion and the plurality of keys of the electronic device.

19. An electronic device as defined in claim 18, further comprising a landing pad attached to the second major surface of the head portion, and the landing pad providing a non-slip contact point between the detachable keyboard and the electronic device.
